(19) United States
(12) Patent Application Publication
(10) Pub. No.: US 2014/0352076 A1
(43) Pub. Date: Dec. 4, 2014

(54) LAUNDRY DETERGENTS

(71) Applicants: Haiyan SONG, Bejing (CN); Ming TANG, Beijing (CN); Rajan (Keshav) PANANDIKER, West Chester, OH (US); Serge (Firmin Alain) CREUTZ, Rocourt (BE); Jacqueline L'HOSTIS, Silly (BE)

(72) Inventors: Haiyan SONG, Bejing (CN); Ming TANG, Beijing (CN); Rajan (Keshav) PANANDIKER, West Chester, OH (US); Serge (Firmin Alain) CREUTZ, Rocourt (BE); Jacqueline L'HOSTIS, Silly (BE)

(21) Appl. No.: 13/906,445

(22) Filed: May 31, 2013

(51) Int. Cl. C11D 3/16

(52) U.S. Cl. CPC C11D 3/162
USPC 8/137; 510/347

(57) ABSTRACT

A laundry detergent having a granulated foam control composition and an anionic surfactant, wherein said granulated foam control composition has a foam control agent having a polydiorganosiloxane fluid, hydrophobic filler, and the granulated foam control composition also has an organic additive composition, a water soluble particulate carrier and a charged cationic polymer. A method of cleaning a fabric, a method of conserving water when washing fabric and a method of saving time through when washing fabric.

### FIELD OF THE INVENTION

The present invention relates to laundry detergents. Specifically, the present invention relates to laundry detergents containing granulated foam control compositions comprising silicones.

### BACKGROUND OF THE INVENTION

Laundry detergents, which contain surfactants and typically anionic surfactants for cleaning fabrics such as clothing have been known for many years. Laundry detergents typically create suds during their use including hand-wash use. During hand washing of clothes and fabrics, where the user is very involved with the washing process, a large volume of suds is initially desirable as it indicates to the user that sufficient surfactant is present, working and cleaning the fabrics. However, during the rinse cycle, a typical hand wash laundry detergent user tends to believe that if suds are still present then there is surfactant residue that remains on the clothes, and therefore believe that the clothes are not yet “clean”. They thus tend to rinse more times until the suds are not seen in the rinse.

Hence, while a large volume of suds is desirable during cleaning, it paradoxically is undesirable during rinsing. Typically it takes between 3-6 rinses to remove such suds to the satisfaction of the person washing. This adds up to a great amount of water which is used every day for rinsing around the world—typically about 5-10 tons of water per year per household in hand wash countries such as India, China, etc. As water is often a limited resource, especially in hand washing countries, the use of water for rinsing reduces the amount available for other possible uses, such as irrigation, drinking, bathing, etc. Depending on the location and the local practice, there may also be an added energy or labor cost associated with rinsing so many times and with so much water.

It has been found that, in fact, fewer rinses can sufficiently remove surfactants and thus multiple rinsing is not necessary. A suds suppressor which is selectively active during rinsing can eliminate unwanted excessive suds during rinsing and thus change the consumer's perception of the sufficiency and efficacy of a single rinse, thereby saving water and effort utilized on repeated rinses.

Suds suppressors are well-known in, for example, automatic dishwashing detergents and laundry detergents for front-loading washing machines. Sample suds suppressors are disclosed in for example, EP1075683A, EP 1070526A, U.S. Pat. No. 7,632,890B and EP 210731A. However, as typical suds suppressors do not distinguish between the wash and rinse conditions, they do not solve the problem of providing suds during washing and yet reducing suds during rinsing. Particularly, in a hand wash situation, the consumers are used to seeing suds during the wash, and if no suds are present, then consumers think that the laundry detergent contains insufficient surfactant to perform up to expectations. PCT publication WO 2007/028773 A1 to Dow Corning published on Oct. 9, 2003 relates to a solid composition for releasing active silicone, which comprises a cationic polymer, an active silicone ingredient and optionally a polymeric thickener and a carrier. The cationic polymer is a homopolymer or a copolymer being prepared from monoethylenically unsaturated monomers. The thickener is a polyacrylate, a polysaccharide, a polymer gum and/or a derivative thereof. Granular encapsulated compositions can be prepared by using the solid silicone-releasing composition as a component in a laundry detergent powder, tablet or bar. This is of interest for the delivery of silicone ingredients in the rinse cycle of a laundry operation.

PCT publication WO 2009/103576 to Unilever published on Aug. 20, 2009 discloses a particle which comprises a silicone oil benefit agent and a charged water soluble polymeric film-forming material, preferably polyvinyl alcohol. The film remains substantially intact in the presence of a surfactant and disintegrates when the concentration of the surfactant reduces sufficiently, thereby releasing the benefit agent. This particle can be incorporated in laundry detergents intended for fabric washing.

US publication 2005/176598 to Catharine et al. published on Aug. 11, 2005 discloses a controlled release delivery system which can be incorporated into a powder detergent for heat triggered delivery of an active agent. The delivery system is a nano-sphere comprising cationic conditioning agent which combines with a cationic charge booster to help adhere the spheres onto a surface.

Therefore, a detergent composition, which provides a satisfying suds volume during the washing stage and a significantly reduced suds volume after a single rinse process, is desired. There have been a number of disclosures relating to detergent composition providing selective reduction of suds in the rinsing stage, but none of them provides as good a well-controlled suds profile during the wash and rinse stages to the extent provided by the present invention.

### SUMMARY OF THE INVENTION

The present invention relates to a laundry detergent comprising a granulated foam control composition and an anionic surfactant, wherein said granulated foam control composition comprises a foam control agent comprising a polydiorganosiloxane fluid, hydrophobic filler, and said granulated foam control composition also comprises an organic additive composition, a water soluble inorganic particulate carrier and a charged polymer. The present invention also relates to a method of cleaning fabric, a method of conserving water when washing fabric and a method of saving time when washing fabric.

The present laundry detergent can provide the level of cleaning expected as evidenced from a desired wash suds volume and yet also help convince users to reduce the number of rinses and thereby save water, effort, resources, etc. through significantly reducing rinse suds volume in a single rinse. Without intending to be limited by theory, it is believed that the anionic surfactants in the laundry detergent coacervate with the granulated foam control composition comprising a foam control agent, and such coacervate keeps intact during washing and only selectively breaks down during rinsing when the surfactant level is decreased.

### DETAILED DESCRIPTION OF THE INVENTION

All temperatures herein are in degrees Celsius (° C.) unless otherwise indicated. As used herein, the term “comprising” means that other steps, ingredients, elements, etc. which do not adversely affect the end result can be added. This term encompasses the terms “consisting of” and “consisting essentially of”. All conditions herein are at 20° C., and atmospheric pressure unless otherwise specifically stated. Unless otherwise specifically stated, the ingredients and equipment herein are believed to be widely available from multiple suppliers and sources around the world. All polymer molecular weights are by average number molecular weight unless otherwise specifically noted.

As used herein, “suds” indicates a non-equilibrium dispersion of gas bubbles in a relatively smaller volume of a liquid. The terms like “suds”, “foam” and “lather” can be used interchangeably in the present specification.

The present invention relates to a laundry detergent comprising a granulated foam control composition and an anionic surfactant, wherein said granulated foam control composition comprises a foam control agent comprising a polydiorganosiloxane fluid, hydrophobic filler, and said granulated foam control composition also comprises an organic additive composition, a water soluble inorganic particulate carrier and a charged polymer. The present invention also relates to a method of cleaning fabric, a method of conserving water when washing fabric and a method of saving time when washing fabric.

The present laundry detergent can be made by combining the granulated foam control composition with an existing laundry powder comprising anionic surfactants.

### Granulate Foam Control Composition

The granulated foam control compositions are typically added to the laundry detergents at a level of from about 0.1%, 0.2%, 0.5% to about 1.0%, 10% by weight. The granulated foam control compositions of the invention were found to have a minimum impact on the foam during the wash, for example less than about 35% foam reduction, or as defined later in the specification, having a wash suds index of at least about 65%, while greatly reducing the foam in the first rinse, for example more than about 50% foam reduction, or as defined later in the present specification, having a rinse suds index of less than about 50%. This was found true when washing by hand but also when using semi-automatic machines.

### Foam Control Agent

The foam control agent comprises a polydiorganosiloxane fluid, a hydrophobic filler and optionally an organosilicone resin. The polydiorganosiloxane fluid can be a polydiorganosiloxane fluid comprising units of the formula:

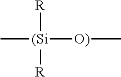

where each group R, which may be the same or different, is selected from an alkyl group having 1 to 36 carbon atoms or an aryl group or aralkyl group having 1 to 36 carbon atoms, the mean number of carbon atoms in the groups R being at least 1.3. In one embodiment, the polydiorganosiloxane fluid preferably has no more than 5 mole % branching units such as RSiO_{3/2} units or crosslink sites, most preferably less than 2 mole % branching units. The mean number of carbon atoms in the groups R is preferably at least 1.3, and is more preferably at least 2.0, most preferably at least 2.5, if the groups R do not include aryl or aralkyl groups. The polydiorganosiloxane fluid is free from non-silicone polymer chains such as polyether chains.

One preferred example of a polydiorganosiloxane fluid is a polysiloxane comprising at least 10% diorganosiloxane units of the formula

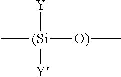

and up to 90% diorganosiloxane units of the formula

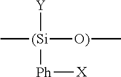

wherein X denotes a divalent aliphatic organic group bonded to silicon through a carbon atom; Ph denotes an aromatic group; Y denotes an alkyl group having 1 to 4 carbon atoms; and Y′ denotes an aliphatic hydrocarbon group having 1 to 24 carbon atoms, as described in EP1075864. The diorganosiloxane units containing a —X-Ph group preferably comprise 5 to 60% of the diorganosiloxane units in the fluid. The group X is preferably a divalent alkylene group having from 2, 4 to 10 carbon atoms, but can alternatively contain an ether linkage between two alkylene groups or between an alkylene group and -Ph, or can contain an ester linkage.

In one embodiment, Ph is a phenyl group, but may be substituted for example by one or more methyl, methoxy, hydroxy or chloro group, or two substituents on the Ph group may together form a divalent alkylene group, or may together form an aromatic ring, resulting in conjunction with the Ph group in e.g. a naphthalene group. In another embodiment, X-Ph group is 2-phenylpropyl —CH₂—CH(CH₃)—C₆H₅. The group Y can be methyl but can be ethyl, propyl or butyl as well. The group Y′ has from 1 or 2 to 16 or 18 carbon atoms, for example it is ethyl, methyl, propyl, isobutyl or hexyl. Mixtures of alkyl groups Y′ can be used, for example ethyl and methyl, or a mixture of dodecyl and tetradecyl. Other groups may be present, for example haloalkyl groups such as chloropropyl, acyloxyalkyl or alkoxyalkyl groups or aromatic groups such as phenyl bonded directly to Si.

The polysiloxane fluid containing —X-Ph groups may be a substantially linear siloxane polymer or may have some branching, for example branching in the siloxane chain by the presence of some tri-functional siloxane units, or branching by a multivalent, e.g. divalent or trivalent, organic or silicon-organic moiety linking polymer chains, as described in EP 1075684A.

An alternative example of a preferred polydiorganosiloxane fluid is a polysiloxane comprising 50-100% diorganosiloxane units of the formula

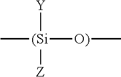

and optionally up to 50% diorganosiloxane units of the formula

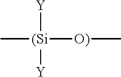

wherein Y denotes an alkyl group having 1 to 4 carbon atoms and Z denotes an alkyl group having 6 to 18 carbon atoms. The groups Y in such a polydiorganosiloxane are preferably methyl or ethyl. The alkyl group Z may preferably have from 6 to 12 or 14 carbon atoms, for example octyl, hexyl, heptyl, decyl, or dodecyl, or a mixture of dodecyl and tetradecyl.

In one embodiment, the number of siloxane units (DP, degree of polymerization) in the average molecule of the polysiloxane fluid of either of the above types is at least 5, more preferably from about 5, 10 and 20 to about 200, 1000 and 5000. The end groups of the polysiloxane can be any of those conventionally present in siloxanes, for example trimethylsilyl end groups.

The polydiorganosiloxane fluid containing —X-Ph groups, or the polydiorganosiloxane fluid containing —Z groups, is preferably present as at least 80%, 95% by weight of the polysiloxane fluid content of the foam control composition, more preferably as 100% of the polysiloxane fluid.

The polydiorganosiloxane fluid can alternatively be a polydiorganosiloxane in which the organic groups are substantially all alkyl groups having 2 to 4 carbon atoms, for example polydiethylsiloxane.

The foam control agent contains a hydrophobic filler dispersed in the polydiorganosiloxane fluid. Hydrophobic fillers for foam control agents are well known and are particulate materials which are solid at 100° C., such as silica, preferably with a surface area as measured by BET measurement of at least 50 m²/g., titania, ground quartz, alumina, an aluminosilicate, zinc oxide, magnesium oxide, a salt of an aliphatic carboxylic acids, a reaction product of an isocyanate with an amine, e.g. cyclohexylamine, or an alkyl amide such as ethylenebisstearamide or methylenebisstearamide. Mixtures of two or more of these can be used.

Some of the fillers mentioned above are not hydrophobic in nature, but can be used if made hydrophobic. This can be done either in situ (i.e. when dispersed in the polysiloxane fluid), or by pre-treatment of the filler prior to mixing with the polysiloxane fluid. A preferred filler is silica which is made hydrophobic. Preferred silica materials are those which are prepared by heating, e.g. fumed silica, or precipitation. The silica filler may for example have an average particle size of 0.5, 2 and 5 to about 25, 30 and 50 μm. It can be made hydrophobic by treatment with a fatty acid, but is preferably made hydrophobic by the use of methyl substituted organosilicon materials such as dimethylsiloxane polymers which are end-blocked with silanol or silicon-bonded alkoxy groups, hexamethyldisilazane, examethyldisiloxane or organosilicone resins containing (CH₃)₃SiO_{1/2} groups and silanol groups. Hydrophobing is generally carried out at a temperature of at least 100° C. Mixtures of fillers can be used, for example a highly hydrophobic silica filler which is commercially available under the name Sipemat D10 from Evonik together with a partially hydrophobic silica such under the name Aerosil R972 from Evonik.

The amount of hydrophobic filler in the foam control agent of the invention is preferably 0.5-50% by weight based on the polysiloxane fluid, more preferably from 1 up to 10 or 15% and most preferably 2 to 8% by weight.

The foam control agent optionally contains an organosilicone resin which is associated with the polydiorganosiloxane fluid. Such an organosilicone resin can enhance the foam control efficiency of the polysiloxane fluid. This is particularly true for polysiloxane fluids containing —X-Ph groups, as described in EP 1075684A, and is also true for polysiloxane fluids containing —Z groups. In such polysiloxane fluids, the resin modifies the surface properties of the fluid.

The organosilicone resin is generally a non-linear siloxane resin and preferably consists of siloxane units of the formula R′aSiO_{4-a/2} wherein R′ denotes a hydroxyl, hydrocarbon or hydrocarbonoxy group, and wherein ‘a’ has an average value of from 0.5 to 2.4. It preferably consists of monovalent trihydrocarbonsiloxy (M) groups of the formula R″₃SiO_{1/2} and tetrafunctional (O) groups SiO_{4/2} wherein R″ denotes a monovalent hydrocarbon group. The number ratio of M groups to Q groups is preferably in the range 0.4:1 to 2.5:1 (equivalent to a value of a in the formula R′ₐSiO_{4-a/2} of 0.86 to 2.15), more preferably 0.4:1 to 1.1:1 and most preferably 0.5:1 to 0.8:1 (equivalent to a=1.0 to a=1.33).

The organosilicone resin is preferably a solid at room temperature. The molecular weight of the resin can be increased by condensation, for example by heating in the presence of a base. The base can for example be an aqueous or alcoholic solution of potassium hydroxide or sodium hydroxide, e.g. a solution in methanol or propanol. A resin comprising M groups, trivalent R″SiO_{3/2} (T) units and Q units can alternatively be used, or up to 20% of units in the organosilicone resin can be divalent units R″₂SiO_{2/2}. The group R″ is preferably an alkyl group having 1 to 6 carbon atoms, for example methyl or ethyl, or can be phenyl. It is particularly preferred that at least 80%, most preferably substantially all, R″ groups present are methyl groups. The resin may be a trimethyl-capped resin.

The organosilicone resin is preferably present in the foam control agent at 1-50% by weight based on the polysiloxane fluid, particularly 2-30% and most preferably 4-15%. The organosilicone resin may be soluble or insoluble in the polysiloxane fluid. If the resin is insoluble in the polysiloxane fluid, the average particle size of the resin may for example be from about 0.5 and 2 to about 50 and 400 μm.

The granulated foam control agent of the invention can contain additional ingredients such as a density adjuster, a color preservative such as a maleate or fumarate, e.g. bis(2-methoxy-1-ethyl)maleate or diallyl maleate, an acetylenic alcohol, e.g. methyl butynol, or cyclooctadiene, a thickening agent such as carboxymethyl cellulose, polyvinyl alcohol or a hydrophilic or partially hydrophobed fumed silica, or a coloring agent such as a pigment or dye.

### Organic Additive Composition

The organic additive of a melting point of from about 45° C. to about 100° C. is miscible with the polydiorganosiloxane fluid. By ‘miscible’, it means that materials in the liquid phase (i.e., molten if necessary) mixed in the proportions in which they are present in the foam control composition do not show phase separation. This can be judged by the clarity of the liquid mixture in the absence of any filler or resin. If the liquids are miscible, the mixture is clear and remains as one phase. If the liquids are immiscible, the mixture is opaque and separates into two phases upon standing. The organic additive increases the foam control efficiency. We have found that additives of melting point at least about 45° C. are effective in increasing foam control efficiency in the rinse.

The organic additive comprises a polyol ester, which is a polyol, partially or fully esterified by carboxylate groups each having 7 to 36 carbon atoms. The polyol ester is preferably a glycerol ester or an ester of a higher polyol such as pentaerythritol or sorbitol. The polyol ester is preferably a monocarboxylate or polycarboxylate (for example a dicarboxylate, tricarboxylate or tetracarboxylate) in which the carboxylate groups each having 18 to 22 carbon atoms. Such polyol carboxylates tend to have a melting point at least 45° C. The polyol ester can be a diester of a glycol such as ethylene glycol or propylene glycol, preferably with a carboxylic acid having at least from 14, 18 to 22 carbon atoms, for example ethylene glycol distearate. Examples of glycerol esters include glycerol tristearate and glycerol esters of saturated carboxylic acids having 20 or 22 carbon atoms such as the material of melting point about 54° C. commercially available under the trade name Synchrowax HRC from Croda, believed to be mainly a triglyceride of C₂₂ fatty acid with some C₂₀ and C₁₈ chains. Alternative suitable polyol esters are esters of pentaerythritol such as pentaerythritol tetrabehenate and pentaerythritol tetrastearate.

The polyol ester can contain fatty acids of different chain length, which is common in natural products. The organic additive can be a mixture of polyol esters, for example a mixture of esters containing different carboxylate groups such as glycerol tripalmitate and glycerol tristearate, or glycerol tristearate and Synchrowax HRC, or ethylene glycol distearate and Synchrowax HRC.

The organic additive can also comprise a more polar polyol ester. In one embodiment, the polar polyol esters include partially esterified polyols including monoesters or diesters of glycerol with a carboxylic acid having 8 to 30 carbon atoms, for example glycerol monostearate, glycerol monolaurate, glycerol distearate or glycerol monobehanate. Mixtures of monoesters and diesters of glycerol can be used. Partial esters of other polyols are also useful, for example propylene glycol monopalmitate, sorbitan monostearate or ethylene glycol monostearate.

The organic additive can be present in the granulated foam control composition at about 10%, 20% to about 100%, 120% and 200% by weight of the polydiorganosiloxane fluid.

### Water Soluble Inorganic Particulate Carrier

The foam control agent is covered by water-soluble inorganic particulate carriers, forming a granulated foam control composition which can readily be incorporated in a detergent powder. Examples of water-soluble inorganic particulate carriers are phosphates, for example powdered or granular sodium tripolyphosphate, sodium sulphate, sodium carbonate, for example anhydrous sodium carbonate or sodium carbonate monohydrate, sodium silicate, sodium citrate, sodium acetate, sodium sesquicarbonate, sodium bicarbonate and mixtures thereof. The particle size of the water-soluble inorganic carrier is preferably in the range of about 1 to about 30 μm, more preferably about 1 to about 20 μm.

We have found that the use of a water-soluble inorganic particulate carrier markedly improves the performance of the granulated foam control composition of the present invention compared to a water-insoluble carrier.

### Charged Polymer

As used herein, the charged polymer can be a cationic polymer, an amphoteric polymer or mixtures thereof. The amphoteric polymers of the present invention will also have a net cationic charge, i.e. the total cationic charges on these polymers will exceed the total anionic charge. The charge density of the charged polymer ranges from about 0.05, 0.5 and 2.5 to about 7, 12 and 23 milliequivalents/g (hereinafter, briefly, “meq/g”). The charge density is calculated by dividing the number of net charge per repeating unit by the molecular weight of the repeating unit. The positive charges could be on the backbone of the polymers or the side chains of polymers. For polymers with amine monomers, the charge density depends on the pH of the carrier. For these polymers, charge density is measured at a pH of 7.

The weight-average molecular weight of the charged polymer will generally be from about 80,000, about 150,000, about 200,000 to about 3,000,000, about 4,000,000, as determined by size exclusion chromatography relative to polyethyleneoxide standards with RI detection. The mobile phase used in the chromatography is a solution of 20% methanol in 0.4M MEA, 0.1 M NaNO₃, 3% acetic acid on a Waters Linear Ultrandyrogel column, 2 in series. Columns and detectors are kept at 40° C. Flow rate is set to 0.5 mL/min.

For the useful charged polymer of the present invention, molecular weight and charge density can act to “compensate” for each other. Lower charge density polymers will work provided their molecular weight is sufficiently high, and lower molecular weight polymers will work provided their charge density is sufficiently high. So, there appears to be an optimum cationicity parameter, where the cationicity parameter is defined as the product of molecular weight*charge density/1000 (MW*CD/1000). Preferred charged polymers have a cationicity parameter of from about 50, about 100, about 150 to about 50,000, about 70,000, about 90,000 meq*Da/g.

Nonlimiting examples of the charged polymer are cationic or amphoteric polysaccharides, proteins and synthetic polymers.

a. Cationic Polysaccharides:

Cationic polysaccharides include but not limited to cationic cellulose derivatives, cationic guar gum derivatives, chitosan and derivatives and cationic starches. Cationic polysaccharides have a molecular weight from about 50,000 to about 2 million, preferably from about 100,000 to about 1,500,000.

One group of preferred cationic polysaccharides is shown in Structural Formula I as follows:

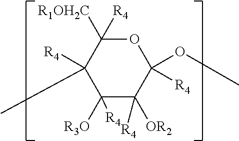

### Structural Formula I

Wherein R¹, R², R³ are each independently H, C1-24 alkyl (linear or branched),

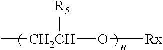

wherein n is from about 0 to about 10; R^{x} is H, C1-24 alkyl (linear or branched) or

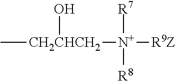

or mixtures thereof, wherein Z is a water soluble anion, preferably chloride, bromide iodide, hydroxide, phosphate sulfate, methyl sulfate and acetate; R⁵ is selected from H, or C1-C6 alkyl or mixtures thereof; R⁷, R⁸ and R⁹ are selected from H, or C1-C28 alkyl, benzyl or substituted benzyl or mixtures thereof.

R⁴ is H or —(P)ₘ—H, or mixtures thereof; wherein P is a repeat unit of an addition polymer formed by a cationic monomer. In one embodiment, the cationic monomer is selected from methacrylamidotrimethylammonium chloride, dimethyl diallyl ammonium having the formula:

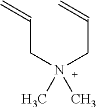

which results in a polymer or co-polymer having units with the formula:

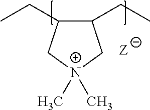

wherein Z′ is a water-soluble anion, preferably chloride, bromide iodide, hydroxide, phosphate sulfate, methyl sulfate and acetate or mixtures thereof and m is from about 1 to about 100.

Alkyl substitution on the saccharide rings of the polymer ranges from about 0.01% to 5% per sugar unit, more preferably from about 0.05% to 2% per glucose unit, of the polymeric material.

Preferred cationic polysaccharides include cationic hydroxyalkyl celluloses. Examples of cationic hydroxyalkyl cellulose include those with the INCI name Polyquaternium10 such as those sold under the trade names Ucare Polymer JR 30M, JR 400, JR 125, LR 400 and LK 400 polymers; Polyquaternium 67 sold under the trade name Softcat SK™, all of which are available from Amerchol Corporation Edgewater N.J.; and Polyquaternium 4 available under the trade name Celquat H200 and Celquat L-200 from National Starch and Chemical Company, Bridgewater, N.J. Other preferred polysaccharides include hydroxyethyl cellulose or hydroxypropylcellulose quaternized with glycidyl C12-C22 alkyl dimethyl ammonium chloride. Examples of such polysaccahrides include the polymers with the INCI names Polyquaternium 24 sold under the trade name Quaternium LM 200, PG-hydroxyethylcellulose lauryldimonium chloride sold under the trade name Crodacel LM, PG-hydroxyethylcellulose cocodimonium chloride sold under the trade name Crodacel QM and, PG-hydroxyethylcellulose stearyldimonium chloride sold under the trade name Crodacel QS and alkyldimethylammonium hydroxypropyl oxyethyl cellulose.

In one embodiment of the present invention, the cationic polymer comprises cationic starch. These are described by D. B. Solarek in Modified Starches, Properties and Uses published by CRC Press (1986) and in U.S. Pat. No. 7,135,451, col. 2, line 33-col. 4, line 67. In another embodiment, the cationic starch of the present invention comprises amylose at a level of from about 0% to about 70% by weight of the cationic starch. In yet another embodiment, when the cationic starch comprises cationic maize starch, the cationic starch comprises from about 25% to about 30% amylose, by weight of the cationic starch. In the above mentioned embodiments, other polymers comprising amylopectin can present in said cationic starch to fill the remainder percentages.

A third group of preferred polysaccharides are cationic galactomanans, such as cationic guar gums or cationic locust bean gum. Examples of cationic guar gum are quaternary ammonium derivatives of hydroxypropyl guar sold under the trade names Jaguar C13 and Jaguar Excel available from Rhodia, Inc of Cranburry N.J. and N-Hance by Aqualon, Wilmington, Del.

b. Synthetic Cationic Polymers

Synthetic cationic polymers in general and their method of manufacture are known in the literature. For example, a detailed description of cationic polymers can be found in an article by M. Fred Hoover that was published in the Journal of Macromolecular Science-Chemistry, A4(6), pp 1327-1417, October, 1970. The entire disclosure of the Hoover article is incorporated herein by reference. Other suitable cationic polymers are those used as retention aids in the manufacture of paper. They are described in “Pulp and Paper, Chemistry and Chemical Technology Volume III edited by James Casey (1981). The molecular weight of these polymers is in the range of about 80,000 to about 4,000,000 Da. The synthetic cationic polymers of this invention will be better understood when read in light of the Hoover article and the Casey book, the present disclosure and the Examples herein.

i. Addition Polymers

Synthetic polymers include but are not limited to synthetic addition polymers of the general structure

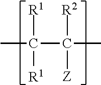

wherein R¹, R², and Z are defined herein below. Preferably, the linear polymer units are formed from linearly polymerizing monomers. Linearly polymerizing monomers are defined herein as monomers which under standard polymerizing conditions result in a linear or branched polymer chain or alternatively which linearly propagate polymerization. The linearly polymerizing monomers of the present invention have the formula:

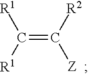

however, those of skill in the art recognize that many useful linear monomer units are introduced indirectly, inter alia, vinyl amine units, vinyl alcohol units, and not by way of linearly polymerizing monomers. For example, vinyl acetate monomers once incorporated into the backbone are hydrolyzed to form vinyl alcohol units. For the purposes of the present invention, linear polymer units may be directly introduced, i.e. via linearly polymerizing units, or indirectly, i.e. via a precursor as in the case of vinyl alcohol cited herein above.

Each R¹ is independently hydrogen, C1-C12 alkyl, substituted or unsubstituted phenyl, substituted or unsubstituted benzyl, —ORa, or —C(O)ORa wherein Ra is selected from hydrogen, and C1-C24 alkyl and mixtures thereof. Preferably R1 is hydrogen, C1-C4 alkyl, —ORa, or —C(O)ORa.

Each R² is independently hydrogen, hydroxyl, halogen, C1-C12 alkyl, —ORa, substituted or unsubstituted phenyl, substituted or unsubstituted benzyl, carbocyclic, heterocyclic, and mixtures thereof. Preferred R² is hydrogen, C1-C4 alkyl, and mixtures thereof.

Each Z is independently hydrogen, halogen; linear or branched C1-C30 alkyl, nitrilo, N(R³)₂—C(O)N(R³)₂, —NHCHO (formamide); —OR³, —O(CH₂)ₙN(R³)₂, —O(CH₂)ₙN+(R³)_{3X}—, —C(O)OR4; —C (O)N—(R³)₂, —C(O)O(CH₂)ₙN(R³)₂, —C(O)O(CH₂)ₙN+(R³)_{3X}, —OCO(CH₂)ₙN(R³)₂, —OCO(CH₂)ₙN+(R³)_{3X}—, —C(O)NH(CH₂)ₙN(R³)₂, —C(O)NH(CH₂)ₙN+(R³)_{3X}—, —(CH₂)ₙN(R³)₂, —(CH₂)ₙN+(R³)_{3X}—,

each R³ is independently hydrogen, C1-C24 alkyl, C2-C8 hydroxyalkyl, benzyl; substituted benzyl and mixtures thereof;

each R⁴ is independently hydrogen or C1-C24 alkyl, and

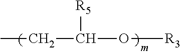

X is a water soluble anion; the index n is from 1 to 6.

R⁵ is independently hydrogen, C1-C6 alkyl,

and mixtures thereof

Z can also be selected from non-aromatic nitrogen heterocycle comprising a quaternary ammonium ion, heterocycle comprising a N-oxide moiety, an aromatic nitrogen containing heterocyclic wherein one or more of the nitrogen atoms is quaternized; an aromatic nitrogen containing heterocycle wherein at least one nitrogen is a N-oxide; or mixtures thereof. Non-limiting examples of addition polymerizing monomers comprising a heterocyclic Z unit includes 1-vinyl-2-pyrrolidinone, 1-vinylimidazole, quaternized vinyl imidazole, 2-vinyl-1,3-dioxolane, 4-vinyl-1-cyclohexenel, 2-epoxide, and 2-vinylpyridine, 2-vinylpyridine N-oxide, 4-vinylpyridine 4-vinylpyridine N-oxide.

A non-limiting example of a Z unit which can be made to form a cationic charge in situ is the —NHCHO unit, formamide. The formulator can prepare a polymer or co-polymer comprising formamide units some of which are subsequently hydrolyzed to form vinyl amine equivalents.

The polymers and co-polymers of the present invention comprise Z units which have a cationic charge or which result in a unit which forms a cationic charge in situ. When the co-polymers of the present invention comprise more than one Z unit, for example, Z1, Z2, . . . Zn units, at least about 1% of the monomers which comprise the co-polymers will comprise a cationic unit.

The polymers or co-polymers of the present invention can comprise one or more cyclic polymer units which are derived from cyclically polymerizing monomers. Cyclically polymerizing monomers are defined herein as monomers which under standard polymerizing conditions result in a cyclic polymer residue as well as serving to linearly propagate polymerization. Preferred cyclically polymerizing monomers of the present invention have the formula:

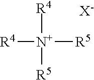

wherein each R⁴ is independently an olefin-comprising unit which is capable of propagating polymerization in addition to forming a cyclic residue with an adjacent R⁴ unit; R⁵ is C1-C12 linear or branched alkyl, benzyl, substituted benzyl, and mixtures thereof; X is a water soluble anion.

Non-limiting examples of R⁴ units include allyl and alkyl substituted allyl units. Preferably, the resulting cyclic residue is a six-member ring comprising a quaternary nitrogen atom.

R⁵ is preferably C1-C4 alkyl, preferably methyl.

An example of a cyclically polymerizing monomer is dimethyl diallyl ammonium having the formula:

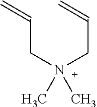

which results in a polymer or co-polymer having units with the formula:

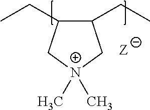

wherein preferably the index z is from about 10 to about 50,000.

Nonlimiting examples of preferred polymers according to the present invention include copolymers made from one or more cationic monomers selected from the group consisting

N,N-dialkylaminoalkyl methacrylate, N,N-dialkylaminoalkyl acrylate, N,N-dialkylaminoalkyl acrylamide, N,N-dialkylaminoalkylmethacrylamide, quaternized N,N-dialkylaminoalkyl methacrylate, quaternized N,N-dialkylaminoalkyl acrylate, quaternized N,N-dialkylaminoalkyl acrylamide, quaternized N,N-dialkylaminoalkylmethacrylamide vinylamine and its derivatives, allylamine and its derivatives, vinyl imidazole, quaternized vinyl imidazole and diallyl dialkyl ammonium chloride, and combinations thereof.

Optionally, a second monomer is selected from a group consisting of acrylamide, N,N-dialkyl acrylamide, methacrylamide, N,N-dialkylmethacrylamide, C1-C12 alkyl acrylate, C1-C12 hydroxyalkyl acrylate, polyalkylene glyol acrylate, C1-C12 alkyl methacrylate, C1-C12 hydroxyalkyl methacrylate, polyalkylene glycol methacrylate, vinyl acetate, vinyl alcohol, vinyl formamide, vinyl acetamide, vinyl alkyl ether, vinyl pyridine, vinyl pyrrolidone, vinyl imidazole and derivatives, acrylic acid, methacrylic acid, maleic acid, vinyl sulfonic acid, styrene sulfonic acid, acrylamidopropylmethane sulfonic acid (AMPS) and their salts, and combinations thereof.

The polymer may optionally be crosslinked. Crosslinking monomers include, but are not limited to, ethylene glycoldiacrylatate, divinylbenzene and butadiene.

Preferred cationic monomers include N,N-dimethyl aminoethyl acrylate, N,N-dimethyl aminoethyl methacrylate (DMAM), [2-(methacryloylamino)ethyl]tri-methylammonium chloride (QDMAM), N,N-dimethylaminopropyl acrylamide (DMAPA), N,N-dimethylaminopropyl methacrylamide (DMAPMA), acrylamidopropyl trimethyl ammonium chloride, methacrylamidopropyl trimethylammonium chloride (MAPTAC), quaternized vinyl imidazole and diallyldimethylammonium chloride and derivatives thereof.

Preferred second monomers include acrylamide, N,N-dimethyl acrylamide, C1-C4 alkyl acrylate, C1-C4 hydroxyalkylacrylate, vinyl formamide, vinyl acetate, and vinyl alcohol. Most preferred nonionic monomers are acrylamide, hydroxyethyl acrylate (HEA), hydroxypropyl acrylate and derivative thereof,

The most preferred synthetic polymers are poly(acrylamide-co-diallyldimethylammonium chloride), poly(acrylamide-methacrylamidopropyltrimethyl ammonium chloride), poly(acrylamide-co-N,N-dimethyl aminoethyl methacrylate), poly(acrylamide-co-N,N-dimethyl aminoethyl methacrylate), poly(hydroxyethylacrylate-co-dimethyl aminoethyl methacrylate), poly(hydroxpropylacrylate-co-dimethyl aminoethyl methacrylate), poly(hydroxpropylacrylate-co-methacrylamidopropyltrimethylammonium chloride), poly(acrylamide-co-diallyldimethylammonium chloride-co-acrylic acid), poly(acrylamide-methacrylamidopropyltrimethyl ammonium chloride-co-acrylic acid).

ii. Polyethyleneimine and its Derivatives.

These are commercially available under the trade name of Lupasol from BASF AG of Ludwigschaefen, Germany. In one embodiment, the polyethylene derivative is an amide derivative of polyetheyleneimine sold under the trade name Lupoasol SK. Also included are alkoxylated polyethleneimine; alkyl polyethyleneimine and quaternized polyethyleneimine.

iii. Polyamidoamine-Epichlorohydrin (PAE) Resins

PAE resin is a condensation product of polyalkylenepolyamine with polycarboxylc acid. The most common PAE resins are the condensation products of diethylenetriamine with adipic acid followed by a subsequent reaction with epichlorohydrin. They are available from Hercules Inc. of Wilmington Del. under the trade name Kymene or from BASF A.G. under the trade name Luresin. These polymers are described in Wet Strength Resins And Their Applications edited by L. L. Chan, TAPPI Press (1994).

### Anionic Surfactant

Anionic surfactant useful for the present laundry detergent is typically the workhorse surfactant, removing dirt and soils from the laundry and forming voluminous, and/or resilient suds during normal use. Thus, this anionic surfactant typically has a sudsing profile of at least about 5 cm, or from about 8 cm to 25 cm, as measured by the below Suds Testing Protocol herein. The level of anionic surfactant is from about 0.5%, 1%, 2%, 5% or 8% to about 20%, 30%, 40%, 50%, by weight of the laundry detergent.

In an embodiment, the anionic surfactant comprises an anionic moiety, or multiple anionic moieties. Without intending to be limited by theory, it is believed that an anionic moiety allows the anionic surfactant to bind with the cationic polymer-coated granulated foam control composition and form a coacervate. The coacervate is believed to be able to adhere and deposit onto a fabric during washing, then selectively break down when the concentration of anionic surfactant drops during the rinsing stage as compared to the concentration in a laundry liquor during washing, thereby releasing the antifoaming composition. In the present invention, the anionic surfactant level in the laundry liquor during washing is at least about 80 ppm, 140 ppm, 200 ppm, 400 ppm, 600 ppm, and the concentration of anionic surfactant during rinsing is no more than ¼ of the anionic surfactant level during wash, for example it is no more than about 200 ppm, about 150 ppm, about 100 ppm, about 80 ppm, about 50 ppm.

In an embodiment the anionic surfactant has an alkyl chain length of from about 6 carbon atoms (C₆), to about 22 carbon atoms (C₂₂), or from about C₁₂ to about C₁₈. Upon physical agitation, anionic surfactants form suds at the air-water interface. Suds indicate to consumers that surfactant is present to release soils, oils, etc. Non-limiting anionic surfactants herein include:
a) linear alkyl benzene sulfonates (LAS), or C₁₁-C₁₈ LAS;
b) primary, branched-chain and random alkyl sulfates (AS), or C₁₀-C₂₀ AS;
c) secondary (2,3) alkyl sulfates having formulas (I) and (II), or C₁₀-C₁₈ secondary alkyl sulfates:

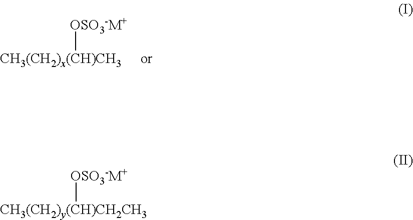

M in formulas (I) and (II) is hydrogen or a cation which provides charge neutrality such as sodium, potassium, and/or ammonium. Above, x is from about 7 to about 19, or about 9 to about 15; and y is from about 8 to about 18, or from about 9 to about 14;
d) alkyl alkoxy sulfates, and alkyl ethoxy sulfates (AEₓS), or C₁₀-C₁₈ AEₓS where x is from about 1 to about 30, or from about 2 to about 10;
e) alkyl alkoxy carboxylates, or C₆-C₁₈ alkyl alkoxy carboxylates, or those with about 1-5 ethoxy (EO) units;
f) mid-chain branched alkyl sulfates as discussed in U.S. Pat. No. 6,020,303 to Cripe, et al., granted on Feb. 1, 2000; and U.S. Pat. No. 6,060,443 to Cripe, et al., granted on May 9, 2000;
g) mid-chain branched alkyl alkoxy sulfates as discussed in U.S. Pat. No. 6,008,181 to Cripe, et al., granted on Dec. 28, 1999; and U.S. Pat. No. 6,020,303 to Cripe, et al., granted on Feb. 1, 2000;
h) modified alkylbenzene sulfonate (MLAS) as discussed in WO 99/05243, WO 99/05242, WO 99/05244, WO 99/05082, WO 99/05084, WO 99/05241, WO 99/07656, WO 00/23549, and WO 00/23548;
h) methyl ester sulfonate (MES); and
i) primary, branched chain and random alkyl or alkenyl carboxylates, or those having from about 6 to about 18 carbon atoms.

In an embodiment, the present laundry detergent can comprise a mixture of anionic surfactants. The anionic surfactant may be a water-soluble salt, or an alkali metal salt, or a sodium and/or potassium salt.

Suds boosting co-surfactants may also be used to boost suds during washing. Many such suds boosting co-surfactants are often also anionic surfactants, and are included in the total anionic surfactant above.

### Additional Detergent Ingredients

The balance of the laundry detergents typically contains from about 5% to about 70%, or about 10% to about 60% adjunct ingredients such as a polymer, a filler, a bleach, a chelant, a calcium carbonate crystal growth inhibitor, a perfume, aesthetics, a bluing agent, a brightener, a non-anionic surfactant, and combinations thereof.

Polymer: Suitable polymers include carboxylate polymers, polyethylene glycol polymers, polyester soil release polymers such as terephthalate polymers, amine polymers, cellulosic polymers, dye transfer inhibition polymers, dye lock polymers such as a condensation oligomer produced by condensation of imidazole and epichlorhydrin, optionally in ratio of 1:4:1, hexamethylenediamine derivative polymers, and any combination thereof.

Carboxylate polymer: Suitable carboxylate polymers include maleate/acrylate random copolymer or polyacrylate homopolymer. The carboxylate polymer may be a polyacrylate homopolymer having a molecular weight of from 4,000 Da to 9,000 Da, or from 6,000 Da to 9,000 Da. Other suitable carboxylate polymers are co-polymers of maleic acid and acrylic acid, and may have a molecular weight in the range of from 4,000 Da to 90,000 Da.

Polyethylene glycol polymer: Suitable polyethylene glycol polymers include random graft co-polymers comprising: (i) hydrophilic backbone comprising polyethylene glycol; and (ii) hydrophobic side chain(s) selected from the group consisting of: C4-C25 alkyl group, polypropylene, polybutylene, vinyl ester of a saturated C1-C6 mono-carboxylic acid, C1-C6 alkyl ester of acrylic or methacrylic acid, and mixtures thereof. Suitable polyethylene glycol polymers have a polyethylene glycol backbone with random grafted polyvinyl acetate side chains. The average molecular weight of the polyethylene glycol backbone can be in the range of from 2,000 Da to 20,000 Da, or from 4,000 Da to 8,000 Da. The molecular weight ratio of the polyethylene glycol backbone to the polyvinyl acetate side chains can be in the range of from 1:1 to 1:5, or from 1:1.2 to 1:2. The average number of graft sites per ethylene oxide units can be less than 1, or less than 0.8, the average number of graft sites per ethylene oxide units can be in the range of from 0.5 to 0.9, or the average number of graft sites per ethylene oxide units can be in the range of from 0.1 to 0.5, or from 0.2 to 0.4. A suitable polyethylene glycol polymer is available under the name Sokalan HP22 from BASF.

Polyester soil release polymers: Suitable polyester soil release polymers have a structure as defined by one of the following structures (I), (II) or (III):

—[(OCHR¹—CHR²)ₐ—O—OC—Ar—CO—]_{d} (I)

—[(OCHR³—CHR⁴)_{b}—O—OC-sAr—CO—]ₑ (II)

—[(OCHR⁵—CHR⁶)_{c}—OR⁷]_{f} (III)

wherein:

a, b and c are from 1 to 200;

d, e and f are from 1 to 50;

Ar is a 1,4-substituted phenylene;

sAr is 1,3-substituted phenylene substituted in position 5 with SO₃Me;

Me is Li, K, Mg/2, Ca/2, Al/3, ammonium, mono-, di-, tri-, or tetraalkylammonium wherein the alkyl groups are C1-C18 alkyl or C2-C10 hydroxyalkyl, or any mixture thereof;

R1, R2, R3, R4, R5 and R6 are independently selected from H or C1-C18 n- or iso-alkyl; and

R7 is a linear or branched C1-C18 alkyl, or a linear or branched C2-C30 alkenyl, or a cycloalkyl group with 5 to 9 carbon atoms, or a C8-C30 aryl group, or a C6-C30 arylalkyl group. Suitable polyester soil release polymers are terephthalate polymers having the structure of formula (I) or (II) above.

Suitable polyester soil release polymers include the Repel-o-tex series of polymers such as Repel-o-tex SF2 from Rhodia and/or the Texcare series of polymers such as Texcare SRA300 from Clariant.

Amine polymer: Suitable amine polymers include polyethylene imine polymers, such as alkoxylated polyalkyleneimines, optionally comprising a polyethylene and/or polypropylene oxide block.

Cellulosic polymer: The composition can comprise cellulosic polymers, such as polymers selected from alkyl cellulose, alkyl alkoxyalkyl cellulose, carboxyalkyl cellulose, alkyl carboxyalkyl, and any combination thereof. Suitable cellulosic polymers are selected from carboxymethyl cellulose, methyl cellulose, methyl hydroxyethyl cellulose, methyl carboxymethyl cellulose, and mixtures thereof. The carboxymethyl cellulose can have a degree of carboxymethyl substitution from 0.5 to 0.9 and a molecular weight from 100,000 Da to 300,000 Da. Another suitable cellulosic polymer is hydrophobically modified carboxymethyl cellulose, such as Finnfix SH-1 from CP Kelco.

Other suitable cellulosic polymers may have a degree of substitution (DS) of from 0.01 to 0.99 and a degree of blockiness (DB) such that either DS+DB is of at least 1.00 or DB+2DS-DS2 is at least 1.20. The substituted cellulosic polymer can have a degree of substitution (DS) of at least 0.55. The substituted cellulosic polymer can have a degree of blockiness (DB) of at least 0.35. The substituted cellulosic polymer can have a DS+DB, of from 1.05 to 2.00. A suitable substituted cellulosic polymer is carboxymethylcellulose.

Another suitable cellulosic polymer is cationically modified hydroxyethyl cellulose.

Dye transfer inhibitor polymer: Suitable dye transfer inhibitor (DTI) polymers include polyvinyl pyrrolidone (PVP), vinyl co-polymers of pyrrolidone and imidazoline (PVPVI), polyvinyl N-oxide (PVNO), and any mixture thereof.

Hexamethylenediamine derivative polymers: Suitable polymers includehexamethylenediamine derivative polymers, typically having the formula:

R₂(CH₃)N+(CH₂)₆N+(CH₃)R₂.2X—

wherein X− is a suitable counter-ion, for example chloride, and R is a poly(ethylene glycol) chain having an average degree of ethoxylation of from 20 to 30. Optionally, the poly(ethylene glycol) chains may be independently capped with sulphate and/or sulphonate groups, typically with the charge being balanced by reducing the number of X− counter-ions, or (in cases where the average degree of sulphation per molecule is greater than two), introduction of Y+ counter-ions, for example sodium cations.

Filler: The laundry detergent may comprise from up to 60% of filler. Suitable fillers include sulphate salts and/or bio-filler materials.

Sulphate salt: A suitable sulphate salt is sodium sulphate. The sulphate salt may have a weight average mean particle size of from 100 to 500 micrometers, alternatively, the sulphate salt may have a weight average mean particle size of from 10 to 25 micrometers.

Bio-filler material: A suitable bio-filler material is alkali treated agricultural waste.

Bleach: The composition may comprise bleach. Alternatively, the composition may be substantially free of bleach; substantially free means “no deliberately added”. Suitable bleach includes bleach activators, sources of available oxygen, pre-formed peracids, bleach catalysts, reducing bleach, and any combination thereof. If present, the bleach, or any component thereof, for example the pre-formed peracid, may be coated, such as encapsulated, or clathrated, such as with urea or cyclodextrin.

Bleach activator: Suitable bleach activators include: tetraacetylethylenediamine (TAED); oxybenzene sulphonates such as nonanoyl oxybenzene sulphonate (NOBS), caprylamidononanoyl oxybenzene sulphonate (NACA-OBS), 3,5,5-trimethyl hexanoyloxybenzene sulphonate (Iso-NOBS), dodecyl oxybenzene sulphonate (LOBS), and any mixture thereof; caprolactams; pentaacetate glucose (PAG); nitrile quaternary ammonium; imide bleach activators, such as N-nonanoyl-N-methyl acetamide; and any mixture thereof.

Source of available oxygen: A suitable source of available oxygen (AvOx) is a source of hydrogen peroxide, such as percarbonate salts and/or perborate salts, such as sodium percarbonate. The source of peroxygen may be at least partially coated, or even completely coated, by a coating ingredient such as a carbonate salt, a sulphate salt, a silicate salt, borosilicate, or any mixture thereof, including mixed salts thereof. Suitable percarbonate salts can be prepared by a fluid bed process or by a crystallization process. Suitable perborate salts include sodium perborate mono-hydrate (PB1), sodium perborate tetra-hydrate (PB4), and anhydrous sodium perborate which is also known as fizzing sodium perborate. Other suitable sources of AvOx include persulphate, such as oxone. Another suitable source of AvOx is hydrogen peroxide.

Pre-formed peracid: A suitable pre-formed peracid is N,N-pthaloylamino peroxycaproic acid (PAP).

Bleach catalyst: Suitable bleach catalysts include oxaziridinium-based bleach catalysts, transition metal bleach catalysts and bleaching enzymes.

Oxaziridinium-based bleach catalyst: A suitable oxaziridinium-based bleach catalyst has the formula:

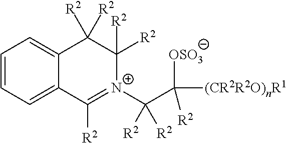

wherein: R1 is selected from the group consisting of: H, a branched alkyl group containing from 3 to 24 carbons, and a linear alkyl group containing from 1 to 24 carbons; R1 can be a branched alkyl group comprising from 6 to 18 carbons, or a linear alkyl group comprising from 5 to 18 carbons, R1 can be selected from the group consisting of: 2-propylheptyl, 2-butyloctyl, 2-pentylnonyl, 2-hexyldecyl, n-hexyl, n-octyl, n-decyl, n-dodecyl, n-tetradecyl, n-hexadecyl, n-octadecyl, iso-nonyl, iso-decyl, iso-tridecyl and iso-pentadecyl; R2 is independently selected from the group consisting of: H, a branched alkyl group comprising from 3 to 12 carbons, and a linear alkyl group comprising from 1 to 12 carbons; optionally R2 is independently selected from H and methyl groups; and n is an integer from 0 to 1.

Transition metal bleach catalyst: The composition may include transition metal bleach catalyst, typically comprising copper, iron, titanium, ruthenium, tungsten, molybdenum, and/or manganese cations. Suitable transition metal bleach catalysts are manganese-based transition metal bleach catalysts.

Reducing bleach: The composition may comprise a reducing bleach. However, the composition may be substantially free of reducing bleach; substantially free means “no deliberately added”. Suitable reducing bleach include sodium sulphite and/or thiourea dioxide (TDO).

Co-bleach particle: The composition may comprise a co-bleach particle. Typically, the co-bleach particle comprises a bleach activator and a source of peroxide. It may be highly suitable for a large amount of bleach activator relative to the source of hydrogen peroxide to be present in the co-bleach particle. The weight ratio of bleach activator to source of hydrogen peroxide present in the co-bleach particle can be at least 0.5:1, at least 0.6:1, at least 0.7:1, 0.8:1, or at least 0.9:1, or 1.0:1.0, or even 1.2:1 or higher.

The co-bleach particle can comprise: (i) bleach activator, such as TAED; and (ii) a source of hydrogen peroxide, such as sodium percarbonate. The bleach activator may at least partially, or even completely, enclose the source of hydrogen peroxide.

The co-bleach particle may comprise a binder. Suitable binders are cellulosic polymers such as carboxymethyl cellulose, and surfactants including anionic detersive surfactants such as linear C11-C13 alkyl benzene sulphonate.

The co-bleach particle may comprise bleach catalyst, such as an oxaziridium-based bleach catalyst.

Photobleach: Suitable photobleaches are zinc and/or aluminium sulphonated phthalocyanines.

Chelant: Suitable chelants are selected from: diethylene triamine pentaacetate, diethylene triamine penta(methyl phosphonic acid), ethylene diamine-N′N′-disuccinic acid, ethylene diamine tetraacetate, ethylene diamine tetra(methylene phosphonic acid), hydroxyethane di(methylene phosphonic acid), and any combination thereof. A suitable chelant is ethylene diamine-N′N′-disuccinic acid (EDDS) and/or hydroxyethane diphosphonic acid (HEDP). The laundry detergent composition may comprise ethylene diamine-N′N′-disuccinic acid or salt thereof. The ethylene diamine-N′N′-disuccinic acid may be in S, S enantiomeric form. The composition may comprise 4,5-dihydroxy-m-benzenedisulfonic acid disodium salt. Suitable chelants may also be calcium crystal growth inhibitors.

Calcium carbonate crystal growth inhibitor: The composition may comprise a calcium carbonate crystal growth inhibitor, such as one selected from the group consisting of: 1-hydroxyethanediphosphonic acid (HEDP) and salts thereof; N,N-dicarboxymethyl-2-aminopentane-1,5-dioic acid and salts thereof; 2-phosphonobutane-1,2,4-tricarboxylic acid and salts thereof; and any combination thereof.

Perfume: Suitable perfumes include perfume microcapsules, polymer assisted perfume delivery systems including Schiff base perfume/polymer complexes, starch-encapsulated perfume accords, perfume-loaded zeolites, blooming perfume accords, and any combination thereof. A suitable perfume microcapsule is melamine formaldehyde based, typically comprising perfume that is encapsulated by a shell comprising melamine formaldehyde. It may be highly suitable for such perfume microcapsules to comprise cationic and/or cationic precursor material in the shell, such as polyvinyl formamide (PVF) and/or cationically modified hydroxyethyl cellulose (catHEC).

Aesthetic: Suitable aesthetic particles include soap rings, lamellar aesthetic particles, geltin beads, carbonate and/or sulphate salt speckles, coloured clay particles, and any combination thereof.

Bluing agents is typically a slightly bluish dye and/or pigment which attaches to fabrics and which helps to hide yellowish tinges and colors on fabrics so as to make the fabric appear whiter. Bluing agents suitable for use herein include: Polar Brilliant Blue GAW 180 percent sold by Ciba-Geigy S.A., Basel, Switzerland (similar to C.I. [“Color Index”] 61135-Acid Blue 127); FD&C Blue No. 1 (C.I. 42090), Rhodamine BM (C.I. 45170); Pontacyl Light Yellow 36 (similar to C.I. 18820); Acid yellow 23; Pigmasol blue; Acid blue 3; Polar Brilliant Blue RAW (C.I. 61585-Acid Blue 80); Phthalocyanine Blue (C.I. 74160); Phthalocyanine Green (C.I. 74260); and Ultramarine Blue (C.I. 77007-Pigment Blue 29). Additional examples of suitable bluing agents are described in U.S. Pat. No. 3,931,037 issued Jan. 6, 1976 to Hall and U.S. Pat. No. 5,605,883 issued Feb. 25, 1997 to Iliff, et al. In an embodiment herein the bluing agent is ultramarine blue which is available from a variety of suppliers worldwide.

Brighteners convert non-visible light into visible light thereby making fabric and clothes appear brighter, whiter and/or their colors more vibrant. Non-limiting examples of brighteners useful herein include brightener 15, brightener 49, manufactured by Ciba Geigy, Paramount, Shanghai Yulong and others. Bluing agents and brighteners are typically present at levels of from about 0.005% to about 3%.

Other surfactants useful herein include cationic surfactants, nonionic surfactants, and amphoteric surfactants. Such surfactants are well known for use in laundry detergents and are typically present at levels of from about 0.2% or 1% to about 40% or 50%.

### Process for Making:

The present laundry detergents are prepared by mixing the granulated foam control composition with an existing laundry detergent comprising anionic surfactant. The existing laundry detergent before mixing with the granulated foam control composition is typically in a form of a water-soluble granule formed by agglomeration and/or spray drying and/or extrusion, and manufacturing processes thereof may be either batch or continuous process, both of which are well known in the art.

Foam control compositions are prepared by first mixing a foam control agent comprising a polysiloxane fluid, a hydrophobic filler, and optionally a organosilicone resin, together with an organic additive. The above mixture in non-aqueous liquid form is deposited on a water soluble inorganic particulate carrier. A charged polymer can be deposited on the particulate carriers in conjunction with the mixture of foam control agent and organic additive, or subsequently. If the charged polymer is deposited on the particulate carrier in conjunction with the mixture of foam control agent and organic additive, it can be premixed with foam control agent and organic additive, or deposited on the particulate carriers simultaneously with the mixture of foam control agent and organic additive.

The mixture of foam control agent and organic additive is preferably deposited on the particulate carriers at a temperature at which the organic additive is liquid, for example a temperature in the range of about 45-100° C. As the mixture cools on the particulate carriers, it solidifies to a structure which contributes to the increased efficiency of the foam control composition. The foam control composition is preferably made by an agglomeration process in which the foam control composition comprising the foam control agent and the organic additive is sprayed onto the particulate carriers while agitating the particles. In one embodiment, the particles are agitated in a high shear mixer through which the particles pass continuously.

One type of suitable mixer is a vertical, continuous high shear mixer in which the foam control composition is sprayed onto the particles. One example of such a mixer is available under the name Flexomix mixer from Hosokawa Schugi.

Alternative suitable mixers which may be used include horizontal high shear mixers, in which an annular layer of the powder-liquid mixture is formed in the mixing chamber, with a residence time of a few seconds up to about 2 minutes. Examples of this family of machines are pin mixers, e.g., TAG series from LB, RM-type machines from Rubberg-Mischtechnik or other pin mixers supplied by Lodige, and paddle mixers, e.g. CB series from Lodige, Corimix from Drais-Manheim and Conax from Ruberg Mischtechnik.

Other possible mixers which can be used in the process of the invention are Glatt granulators, ploughshare mixers, as sold for example by Lodige GmbH, twin counter-rotating paddle mixers commercially available under the name Forberg, intensive mixers including a high shear mixing arm within a rotating cylindrical vessel, commercially available under the name Typ R from Eirich, under the name Zig-Zag from Patterson-Kelley, and under the name HEC from Niro.

### Wash Suds Index and Rinse Suds Index

Wash Suds Index is used to compare the suds volume generated during the washing stage by the present laundry detergent comprising a granulated foam control composition versus a laundry detergent alone without the present granulated foam control composition as a control. Herein, the suds volume is measured by the suds height following a standardized washing process described below.

Rinse Suds Index is used to compare the suds volume remaining after rinsing of the present laundry detergents comprising granulated foam control composition versus the laundry detergents alone as a control. Herein the suds volume is measured by the surface area of suds in a rinsing basin following a standardized rinsing process described below.

The present laundry detergent used to conduct the experiments includes by weight of the laundry detergent, 0.05% of present and comparative granulated foam control composition, 11% of linear alkyl benzene sulphonate, 1% of alkyl dimethyl hydroxylethyl ammonium chloride, 3.5% of C14-15 alkyl ethoxylated alcohol having a molar average degree of ethoxylation of 9, 20% sodium alumino silicate (Zeolite), 15% sodium carbonate, 28% sodium sulphate, 2% sodium silicate, 1.5% carboxy methyl cellulose, 4% of poly acrylic acid, 2% sodium percarbonate, 0.5% of tetraacetylethylenediamine (TAED), and includes enzymes et. al which make the total amount of all the components add up to 100%.

Standard Washing process:
1) Fill a basin with 2 L DI water (4 gpg) and dissolve the laundry detergents to reach a concentration of 3500 ppm in the water and swirl for 2 min until it fully dissolves and forms a laundry liquor.
2) Put a piece of fabric into the laundry liquor and soak for 5 min.
3) For each piece of fabric, scrub it 5 times, dip back into the laundry liquor between each scrub.
4) Wring the scrubbed fabric gently, not disturbing the suds produced.
5) Measure the total height of the suds and laundry liquor, by taking a average from five measures including one center point and four edge points of the basin;
6) Measure the laundry liquor height in the basin by removing suds from the basin;
7) Get suds height by deducting the measurement in step 6) from step 5).

Standard Rinsing process:
1) Put the washed and wringed piece of fabric into a new basin comprising 2 L of fresh DI water (4 gpg) by control the laundry liquor carryover to be 200±5 g (carryover=total weight after wash−dry fabric weight). Rinse each piece of fabric through 3 gentle scrubs.
2) Take a picture for the suds coverage on the rinse water surface on 5-10 sec after removing the piece of fabric from the water.
   As a summary, the conditions set for the washing and rinsing process are provided in below table.

| | | | |
|---|---|---|---|
| Product concentration | 3500 ppm | Soaking time: | 5 min |
| Water volume: | 2 L | Washing scrubs: | 5 scrubs |
| Water hardness | 4 gpg, Ca: Mg = 4:1 | 1^{st}/2^{nd} rinse time: | 3 scrubs |
| Water temperature | 20-25° C. | Rinse method: | Hand wash |

| | |
|---|---|
| Grading method: | Ruler to measure suds height when coverage area =100% or |
| | picture for coverage percentage when coverage <100% |
| Fabric: | 1 piece of terry towel (20 cm × 20 cm), 2 pieces of knitted |
| | cotton (40 cm × 40 cm). Total dry weight = 115 ± 3 g |

### EXAMPLES

The following examples further describe and demonstrate embodiments within the scope of the present invention. The examples are given solely for the purpose of illustration and are not to be construed as limitations of the present invention, as many variations thereof are possible without departing from the spirit and scope of the invention.

Below examples 1-9 describe the making of the granulated foam control compositions according to the present invention, while comparative Examples C1-C3 relate to those not according to the present invention. The granulated foam control compositions are made by mixing a foam control agent, an organic additive composition, a water soluble inorganic particulate carrier and a charged polymer together. When such granulated foam control compositions are made, each of them is further mixed with an existing laundry detergent to make the present laundry detergent. As describe in previous paragraph, the present laundry detergent used to conduct the experiments includes by weight of the laundry detergent, 0.05% of present and comparative granulated foam control composition, 11% of linear alkyl benzene sulphonate, 1% of alkyl dimethyl hydroxylethyl ammonium chloride, 3.5% of C14-15 alkyl ethoxylated alcohol having a molar average degree of ethoxylation of 9, 20% sodium alumino silicate (Zeolite), 15% sodium carbonate, 28% sodium sulphate, 2% sodium silicate, 1.5% carboxy methyl cellulose, 4% of poly acrylic acid, 2% sodium percarbonate, 0.5% of tetraacetylethylenediamine (TAED), and includes enzymes et. al which make the total amount of all the components add up to 100%.

### Example 1

Six percent (6%) by weight treated precipitated silica available under the name Sipernat D10 from Evonik and 1% partially hydrophobic silica available under the name R972 from Evonik are dispersed in 86.3% polydiorganosiloxane fluid having a degree of polymerisation of 65 and comprising 80 mole % methyl ethyl siloxane groups, 19 mole % methyl 2-phenylpropyl (derived from α-methylstyrene)siloxane groups and 1 mole % divinyl crosslinking groups. 6.7% by weight of a 60% by weight solution of an organosiloxane resin having trimethyl siloxane units and SiO2 units in a M/Q ratio of 0.65/1 in octyl stearate (70% solid) is added. The mixture is homogenized through a high shear mixer to form a foam control agent FC1.

Thirteen point five (13.5) parts of above foam control agent FC1 is mechanically mixed with 9 parts of glyceryl tribehenate provided by Oleon. The FC1 and motlen glyceryl tribehenate are mixed at 70° C. The glyceryl monobehenate and polydiorganosiloxane fluid are miscible and the mixture has a melting point of 65° C. The mixture of glyceryl tribehenate and FC1, and 4.5 parts of a 1% aqueous solution of Polyquaternium-10 JR 30M cationic polymer, are poured slowly into a mixer where 73.5 parts of sodium sulfate powder is already being stirred. Polyquaternium-10 JR 30M is provided by Dow Chemicals and is a polymeric quaternary ammonium salt formed by reacting hydroxyethyl cellulose with a trimethyl ammonium substituted epoxide, and has a Mw of 800,000 and a charge density of 1.25 meq/g. The mixture is stirred continuously until a granular particulate material was obtained. The water contained in this granulated foam control composition is removed in a fluidized bed using air at 30° C.

A granulated foam control composition is achieved.

### Example 2

Another similar foam control agent FC2 is prepared, which is essentially the same as FC1, except that polydiorganosiloxane fluid is different from that in FC1. In FC2, 86.3% polydiorganosiloxane fluid having a degree of polymerisation of 65 and comprising 80 mole % methyl dodecyl siloxane groups, 20 mole % methyl 2-phenylpropyl (derived from [alpha]-methylstyrene)siloxane groups are used instead.

Fourteen (14) parts of above foam control agent FC2 is mechanically mixed with 9 parts of glyceryl tristearate provided by Oleon. The FC2 and motled glyceryl tristearate are mixed at 70° C. The glyceryl tristearate and polydiorganosiloxane fluid are miscible and the mixture has a melting point of 62° C. The mixture of glyceryl tristearate and FC2, and 4 parts of a 1% aqueous solution of Polyquaternium-10 JR 30M cationic polymer, are poured slowly into a mixer where 73 parts of sodium sulfate powder is already being stirred. The mixture is stirred continuously until a granular particulate material is obtained. The water contained in this granulated foam control composition is removed in a fluidized bed using air at 30° C.

A granulated foam control composition is achieved.

### Example 3

Twelve point five (12.5) parts of above foam control agent FC2 is mechanically mixed with 7.5 parts of glyceryl tribehenate provided by Oleon. The FC2 and motled glyceryl tristearate are mixed at 70° C. The glyceryl tribehenate and polydiorganosiloxane fluid are miscible and the mixture had a melting point of 65° C. The mixture of glyceryl tribehenate and FC2, and 5 parts of a 6.2% aqueous solution of a copolymer PAM/MAPTCAC having a molecular weight of 1,100,000 Da from Nalco, comprising 88 parts of polyacrylamide monomer units (PAM) and 12 parts of methacrylamidopropyl trimethylammonium chloride monomer units (MAPTCAC), are poured slowly into a mixer where 75 parts of sodium sulfate powder is already being stirred. The mixture is stirred continuously until a granular particulate material is obtained. The water contained in this granulated foam control composition is removed in a fluidized bed using air at 30° C.

A granulated foam control composition is achieved.

### Examples 4 to 6

Thirteen point five (13.5) parts by weight of the foam control agent FC2 is mixed with 9 parts of molten glyceryl tribehenate at 70° C. The mixture of glyceryl tribehenate and FC2, and 4.5 parts of a 1% aqueous solution of a cationic polymer, are poured slowly into a mixer where 73.5 parts of sodium sulfate powder is already being stirred. The mixture is stirred continuously until a granular particulate material is obtained. The water contained in this granulated foam control composition is removed in a fluidized bed using air at 30° C. Granulated foam control compositions are achieved.

The cationic polymers used in Examples 4 to 6 are:

### Example 4

### Polyquaternium-10/JR 30M

### Example 5

Polyquaternium-10/LR 30M, which is a polymeric quaternary ammonium salt formed by reacting hydroxyethyl cellulose with a trimethyl ammonium substituted epoxide, and has a molecular weight of about 350,000 and a charge density of 0.7 meq/g.

### Example 6

Polyquaternium-10/JR 125, which is a polymeric quaternary ammonium salt formed by reacting hydroxyethyl cellulose with a trimethyl ammonium substituted epoxide, and has a molecular weight of 80,000 and a charge density of 1.25 meq/g.

### Comparative Example C1

Sixty-nine (69) parts of zeolite commercially available under the name zeolite A from Ineos are mixed with approximately 8.5 parts of glyceryl monobehenate from Croda, approximately 13 parts of FC2, and approximately 9.5 parts of a Polyquaternium-10 solution at 1%. The mixture is prepared by mechanically mixing the silicone with the molten glyceryl monobehenate at 80° C. This mixture and a Polyquaternium-10 aqueous solution at 1% are poured slowly into a mixer where the zeolite is already present. The mixture is stirred continuously until a particulate material is obtained. The water contained in the granular material is removed in a fluidized bed using air at 30° C.

### Comparative Example C2

Sixty-eight (68) parts of sodium sulphate are mixed with approximately 8 parts of glyceryl monobehenate provided by Croda, approximately 12.5 parts of FC2, and approximately 10.5 parts of acylic/maleic copolymer provided by BASF under the name Sokalan® CP5. The mixture is prepared by mechanically mixing the silicone with the molten glyceryl monobehenate at 80° C. This mixture and the acrylic/maleic copolymer are poured slowly into a mixer where the Na sulfate is already present. The mixture is stirred continuously until a particulate material is obtained. The water contained in the granular material is removed in a fluidized bed using air at 30° C.

### Comparative Example C3

Sixty-nine point 5 (69.5) parts of sodium sulfate are mixed with approximately 9.5 parts of microcrystalline wax from A&E Connock, approximately 14 parts of FC2, and approximately 6.5 parts of a polyMADAME aqueous solution at 1% which is poly-dimethylaminoethylmethacrylate with no charge density prepared by Dow Corning. The mixture is prepared by mechanically mixing the silicone with the molten microcrystalline wax, this mixture and the polyMADAME aqueous solution at 1% are poured slowly into a mixer where the sodium sulfate is already present. The mixture is stirred continuously until a particulate material is obtained. The water contained in the granular material is removed in a fluidized bed using air at 30° C.

### Comparative Example C4

Eighty (80) parts of sodium sulfate are mixed with approximately 11 parts of glyceryl tribehenate from Oleon, and approximately 9 parts of a Polyquaternium-10 JR 30M solution at 0.5%. The molten glyceryl tribehenate and the Polyquaternium-10 JR 30M aqueous solution at 0.5% are poured slowly into a mixer where the sodium sulfate is already present. The mixture is stirred continuously until a particulate material is obtained. The water contained in the granular material is removed in a fluidized bed using air at 30° C.

The laundry detergent containing granulated antifoam compositions described in Examples 1 to 6, and comparative Examples C1-C4 are tested for suds index during washing and during rinsing according to the test protocol described above. The results are shown in Table 1 below.

TABLE 1

| | Examples | | | | | | | | | |
|---|---|---|---|---|---|---|---|---|---|---|
| | 1 | 2 | 3 | 4 | 5 | 6 | C1 | C2 | C3 | C4 |
| Wash | 67% | 78% | 96% | 83% | 79% | 66% | 100% | 59% | 67% | 89% |
| Suds | | | | | | | | | | |
| Index | | | | | | | | | | |
| Rinse | 40% | 15% | 20% | 50% | 50% | 25% | 100% | 80% | 60% | 95% |
| Suds | | | | | | | | | | |
| Index | | | | | | | | | | |
| Mw of | 800,000 | 800,000 | 800,000 | 800,000 | 300,000-400.000 | 80,000.00 | Insoluble | Anionic | non- | No |
| cationic | | | | | | | particulate | polymer | charged | silicone |
| polymer | | | | | | | carrier | | polymer + | fluid |
| Charge | 1.25 | 1.25 | 1.25 | 1.25 | 0.7 | 1.25 | | | different | |
| density | | | | | | | | | wax | |
| (meq/g) | | | | | | | | | | |
| Cationicity | 1000 | 1000 | 1000 | 1000 | 210-280 | 100 | | | | |
| (meq * Da/g) | | | | | | | | | | |

It can be seen that Examples 1 to 6 using the present laundry detergent comprising granulated foam control compositions all have a minimum impact on the foam during washing (wash suds index of greater than 65%, i.e., less than 35% wash suds reduction), and have greatly reduced foam during rinsing (rinse suds index of less than 50%).

Comparative example C1 using an insoluble particulate carrier in building the granulated foam control composition had no impact on the foam in the rinse (rinse suds index is greater than 50%), comparative example C2 using anionic polymer for the granulated foam control composition has a significant impact on the foam during washing (its suds index is less than 65%), and does not reduce rinse suds, in fact the rinse suds in higher in rinsing than in washing. Comparative Example C3 using different a cationic polymer and a different wax from that of present invention shows acceptable wash suds, but the rinse suds reduction is not satisfying enough (rinse suds over 50%). Comparative example C4 without silicone for the granulated foam control composition barely shows any decrease of the rinse suds (rinse suds index of 95%).

### Example 7

Fourteen (14) parts by weight of the foam control agent FC2 is mechanically mixed with 9 parts of glyceryl monobehenate from Croda. The FC2 and molten glyceryl monobehenate are mixed at 70° C. The glyceryl monobehenate and polydiorganosiloxane fluid are miscible and the mixture has a melting point of 69° C. The mixture of glyceryl monobehenate and FC2, and 3 parts of a 1% aqueous solution of Polyquaternium-10/JR 30M cationic polymer, are poured slowly into a mixer where 78 parts of sodium sulfate powder is already being stirred. The mixture is stirred continuously until a granular particulate material is obtained. The water contained in this granulated foam control composition is removed in a fluidized bed using air at 30° C. A granulated foam control composition is achieved.

### Example 8

Eight (8) parts by weight of the foam control agent FC2 is mechanically mixed with 5 parts of glyceryl tristearate provided by Oleon. The FC2 and molten glyceryl tristearate are mixed at 80° C. The mixture of glyceryl tristearate and FC2, and 6.5 parts of a 6.2% aqueous solution of cationic polymer CP1, are poured slowly into a mixer where 73 parts of sodium sulfate powder is already being stirred. The mixture is stirred continuously until a granular particulate material is obtained. The water contained in this granulated foam control composition is removed in a fluidized bed using air at 30° C. A granulated foam control composition is achieved.

### Example 9

Nine point 5 (9.5) parts by weight of the foam control agent FC2 is mechanically mixed with 6.5 parts of glyceryl tristearate from Sasol. The FC2 and molten glyceryl tristerate are mixed at 80° C. The glyceryl tristearate and polydiorganosiloxane fluid are miscible and the mixture has a melting point of 70° C. The mixture of glyceryl tristearate and FC2, and 4 parts of a 6.2% aqueous solution of a cationic polymer CP1, are poured slowly into a mixer where 80 parts of sodium sulfate powder heated at 70° c. is already being stirred. The mixture is stirred continuously until a granular particulate material is obtained. The water contained in this granulated foam control composition is removed in a fluidized bed using air at 30° C. A granulated foam control composition is achieved.

The laundry detergent containing granulated antifoam composition described in Examples 7 to 9, are tested for foam in the wash and in the rinse by the test protocol described above, except that 3 pieces of knitted cotton having total dry weight of 120±5 g are used instead of 1 towel and 2 knitted cotton having total weight of 115±3 g used for Examples 1-6. Wash suds height in the wash basin and rinse suds coverage in the rinse basin are presented in table 2 below, as compared to those suds height in the same wash basin and suds coverage in the same rinse basin generated by detergent alone without granulated foam composition as a control.

TABLE 2

| | | Rinse Suds surface |
|---|---|---|
| | Wash Suds height in basin | coverage in basin |
| control: | 6.9 cm | 100% |
| detergent alone | | |
| Example7 | 6.7 cm | 10% |
| Example 8 | 6.4 cm | 15% |
| Example 9 | 6.5 cm | 20% |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A laundry detergent comprising a granulated foam control composition and an anionic surfactant, wherein said granulated foam control composition comprises:
(a) a foam control agent comprising:
i. a polydiorganosiloxane fluid comprising units of the formula 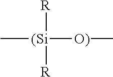
where each group R, which may be the same or different, is selected from an alkyl group having 1 to 36 carbon atoms or an aryl group or aralkyl group having 1 to 36 carbon atoms, the mean number of carbon atoms in the groups R being at least 1.3;
(b) ii. a hydrophobic filler dispersed in the polydiorganosiloxane fluid; an organic additive composition having a melting point of from about 45° C. to about 100° C. comprising a polyol ester which is a polyol esterified by carboxylate groups each having 7 to 36 carbon atoms, and which is miscible with said polydiorganosiloxane fluid;
(c) a water soluble inorganic particulate carrier;
(d) a charged polymer with a net charge density of from about 0.05 to about 23 meq/g and a molecular weight of from about 80,000 to about 4,000,000 Daltons, wherein said charged polymer has a cationicity parameter of great than 50 meq*Da/g.

2. The laundry detergent according to claim 1, wherein said polydiorganosiloxane fluid is a polysiloxane comprising at least 10% diorganosiloxane units of the formula 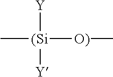
and up to 90% diorganosiloxane units of the formula 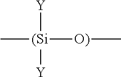
wherein X denotes a divalent aliphatic organic group bonded to silicon through a carbon atom; Ph denotes an aromatic group; Y denotes an alkyl group having 1 to 4 carbon atoms; and Y′ denotes an aliphatic hydrocarbon group having 1 to 24 carbon atoms.

3. The laundry detergent according to claim 1, wherein the polydiorganosiloxane fluid is a polysiloxane comprising 50-100% diorganosiloxane units of the formula 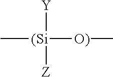
wherein Y denotes an alkyl group having 1 to 4 carbon atoms and Z denotes an alkyl group having 6 to 18 carbon atoms.

4. The laundry detergent according to claim 3, wherein the polydiorganosiloxane fluid further comprises up to 50% diorganosiloxane units of the formula 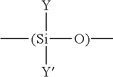
wherein Y denotes an alkyl group having 1 to 4 carbon atoms and Z denotes an alkyl group having 6 to 18 carbon atoms.

5. The laundry detergent according to claim 1, wherein the mixture of the organic additive and the polydiorganosiloxane fluid has a melting point of about 45° C. to 100° C.

6. The laundry detergent according to claim 1, wherein the polyol ester is a glycerol triester substantially fully esterified by carboxylate groups each having 14 to 22 carbon atoms.

7. The laundry detergent according to claim 1, wherein the polyol ester is a monocarboxylate or polycarboxylate in which the carboxylate groups each has 18 to 22 carbon atoms.

8. The laundry detergent according to claim 1, wherein the water soluble inorganic particulate carrier is selected from the group consisting of sodium sulfate, sodium carbonate, sodium bicarbonate, and combinations thereof.

9. The laundry detergent according to claim 1, wherein said charged polymer is a cationic polysaccharide.

10. The laundry detergent according to claim 1, wherein said charged polymer is a synthetic addition polymer of the general structure 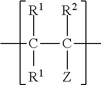
wherein each R¹ is independently hydrogen, C₁-C₁₂ alkyl, substituted or unsubstituted phenyl, substituted or unsubstituted benzyl, —ORₐ, or —C(O)ORₐ wherein Rₐ is selected from hydrogen and C₁-C₂₄ alkyl and mixtures thereof; each R² is independently hydrogen, hydroxyl, halogen, C₁-C₁₂ alkyl, —ORₐ, substituted or unsubstituted phenyl, substituted or unsubstituted benzyl, carbocyclic or heterocyclic; and each Z is independently hydrogen, halogen; linear or branched C₁-C₃₀ alkyl, nitrilo, N(R₃)₂—C(O)N(R₃)₂; —NHCHO (formamide); —OR³, —O(CH₂)ₐN(R³)₂, —O(CH₂)ₙN⁺(R³)₃X⁻, —C(O)OR⁴; —C(O)N—(R³)₂, —C(O)O(CH₂)ₙN(R³)₂, —C(O)O(CH₂)ₙN⁺(R³)₃X⁻, —OCO(CH₂)ₙN(R³)₂, —OCO(CH₂)ₙN⁺(R³)₃X⁻, —C(O)NH—(CH₂)ₙN(R³)₂, —C(O)NH(CH₂)ₙN⁺(R³)₃X⁻, —(CH₂)ₙN(R³)₂, —(CH₂)ₙN⁺(R³)₃X⁻, or a non-aromatic nitrogen heterocycle comprising a quaternary ammonium ion, heterocycle comprising an N-oxide moiety, an aromatic nitrogen containing heterocyclic wherein one or more or the nitrogen atoms is quaternized; an aromatic nitrogen containing heterocycle wherein at least one nitrogen is an N-oxide; each R₃ being independently hydrogen, C₁-C₂₄ alkyl, C₂-C₈ hydroxyalkyl, benzyl or substituted benzyl; each R₄ being independently hydrogen or C₁-C₂₄ alkyl or —(CH₂—CHR₅—O)ₘ—R³, where R₅ is independently hydrogen or C₁-C₆ alkyl; X being a water soluble anion; and n being from 1 to 6; provided that at least one Z group per molecule is selected from —O(CH₂)ₙN⁺(R³)₃X⁻, —C(O)OR⁴; —C(O)N—(R³)₂, —C(O)O(CH₂)ₙN(R³)₂, —C(O)O(CH₂)ₐN⁺(R³)₃X⁻, —OCO(CH₂)ₙN(R³)₂, —OCO(CH₂)ₙN⁺(R³)₃X⁻, —C(O)NH—(CH₂)ₙN(R³)₂, —C(O)NH(CH₂)ₙN⁺(R³)₃X⁻, —(CH₂)ₙN(R³)₂, —(CH₂)ₙN⁺(R³)₃X⁻, or a non-aromatic nitrogen heterocycle comprising a quaternary ammonium ion, heterocycle comprising a N-oxide moiety, an aromatic nitrogen-containing heterocyclic wherein one or more or the nitrogen atoms is quaternized; an aromatic nitrogen-containing heterocycle wherein at least one nitrogen is an N-oxide.

11. The laundry detergent according to claim 1, wherein the foam control agent additionally comprises an organosilicone resin, which is a siloxane resin consisting of monovalent trihydrocarbonsiloxy (M) groups of the formula R″₃SiO_{1/2} and tetrafunctional Q groups SiO_{4/2}, wherein R″ denotes an alkyl group and the number ratio of M groups to Q groups is in the range 0.4:1 to 1.1:1.

12. A method of cleaning fabric, said method comprising the steps of:
a) providing a laundry detergent according to claim 1;
b) forming a laundry liquor by diluting the laundry detergent, wherein the anionic surfactant level of the laundry liquor is at least 80 ppm;
c) washing the fabric in the laundry liquor;
d) rinsing the fabric in water, wherein the anionic surfactant level is no more than ¼ of the level in step b).

13. A method of conserving water when washing fabric, said method comprising the step of washing a fabric according to the method of claim 12, wherein step d) is performed one time.

14. A method of saving time when washing fabric, said method comprising the step of washing a fabric according to the method of claim 12, wherein step d) is performed one time.
